(19) United States
(12) Patent Application Publication
(10) Pub. No.: US 2007/0229463 A1
(43) Pub. Date: Oct. 4, 2007

(54) Device and program for keyboard management

(75) Inventor: Yasushi Tsukamoto, Osaka (JP)

Correspondence Address: Kyocera Technology Development;Intellectual Property Administration, Suite 400, 1855 Gateway Blvd., Concord, CA, 94520, US

(73) Assignee: Kyocera Mita Corporation, Osaka-shi (JP)

(21) Appl. No.: 11/724,468

(22) Filed: Mar. 15, 2007

(30) Foreign Application Priority Data
Mar. 29, 2006 (JP) JP2006-090075

(51) Int. Cl. G09G 5/00

(52) U.S. Cl. 345/172

(57) ABSTRACT

A keyboard management method, program product, and system for switching display of keyboards supporting multiple languages for MFPs. An inner keyboard data memory unit stores in advance keyboard data and font data to be displayed on a display panel associated with the keyboard data. An external keyboard data memory unit stores additional keyboard data and additional font data to be displayed associated with the additional keyboard data. An additional keyboard registration control unit controls registration of the additional keyboard data and the additional font data to the external keyboard data memory unit. A display keyboard creation unit creates display keyboard data from keyboard data selected from the internal or external keyboard data memory unit and font data associated with key locations of the selected keyboard data.

### FIELD OF THE INVENTION

The present invention relates to a device and a program for keyboard management, and more particularly, to a keyboard management device and a keyboard management program installed to optimally function on Multifunction Peripherals or Multi-Functional Peripherals (hereinafter “MFP(s)”) having multiple functions such as of a printer, a copier, and a facsimile.

### BACKGROUND OF THE INVENTION

In recent years, provided for MFPs are devices that are functional in multiple languages not only Japanese but also English, Korean, and Chinese. Configurations of existing MFPs supporting multiple languages are such that unless a desired language font data is stored in each print font data unit, transmission font data unit, and display font data memory unit, image data cannot be created, characters cannot be added to image data, and output cannot be made to the display panel.

However, storing of multiple language font data in advance is considerably costly, and required languages differ from user to user. Accordingly, a conventional MFP stores soft keyboard layout data and key font data to be displayed on key locations of the soft keyboard layout data of one to two main languages in addition to a language used in a country a device is installed as those of a standard language or languages on the display font data memory unit, and is configured to enable switching display of multiple soft keyboards mainly from the display panel to minimize inconvenience in panel operation.

A problem with the aforementioned MFPs is that although they have become connected through networks along with the increase in their use in various countries, their ability to display only a standard language keyboard can limit their use to a certain country.

### SUMMARY OF THE INVENTION

The present invention addresses the above-described issues by providing a keyboard management device and a keyboard management program which allow switching display of keyboards supporting multiple languages.

The following is a configuration of conventional MFPs that are functional in multiple languages other than Japanese, such as English, Korean, and Chinese.

FIG. 1 shows a configuration of a conventional MFP. It creates print image data from input printer data with font data acquired from a print font data memory unit 3 at a printer control unit 1 and outputs the data to an image control unit 5, or outputs image data read from a scanner processing unit 7 to the image control unit 5. Based on a command from a display panel 11 through a panel control unit 9, the MFP prints out such print image data or read image data by controlling output of the data at the image control unit 5 to a printer processing unit 13. Alternatively, the MFP, based on a command from a display panel 11 through a panel control unit 9, adds a name and/or an ID of a transmitter and/or a recipient created with transmission font data from a transmission font data memory unit 17 at a transmission image control unit 19 to the header and/or the footer of the data and transmits the data through facsimile to an external network (not shown) by controlling output of the data at the image control unit 5 to a transmission control unit 15. Additionally, the MFP displays various display data from the image control unit 5 on the display panel 11, through the panel control unit 9.

A display font data memory unit 21 of FIG. 1 stores display font data to be displayed on the display panel 11, whose read-and-write operations are controlled by the panel control unit 9. A reception process unit 23 outputs, for example, a facsimile signal received from a network to the image control unit 5.

For making this type of MFP functional in multiple languages, unless a desired language font data is stored into each of the print font data unit 3, the transmission font data unit 17, and the display font data memory unit 21, image data cannot be created, characters cannot be added to image data, and output cannot be made to the display panel 11. However, storing of multiple language font data in advance is considerably costly, and required languages differs from user to user.

Accordingly, a conventional MFP stores soft keyboard layout data and key font data to be displayed on key locations of the soft keyboard layout data of one to two main languages in addition to a language used in a country a device is installed as the data of a standard language or languages (for example, Japanese and alphanumeric characters) on the display font data memory unit 21. Additionally, it is configured to enable switching display of multiple soft keyboards mainly from the display panel 11 to minimize inconvenience in panel operation.

In the preferred embodiments of the present invention, such soft keyboards and soft keyboard layouts are simply referred to as keyboards and keyboard layouts.

A method for supporting multiple languages is disclosed, for example, in Japanese Patent Application Laid-Open No. 2002-204322.

A problem with the aforementioned MFPs is, however, that although they have become connected through networks along with the increase in their use in various countries, their limited ability to display only a standard language keyboard can restrict their use to a certain country.

Furthermore, because key font data to be allocated to a keyboard layout is set in advance, users have faced inconveniences and long waited for an invention that improves MFPs usability.

A keyboard management device of the present invention for solving such issues has a first keyboard data memory, a second keyboard data memory unit, an additional keyboard registration control unit, and a display keyboard creation unit.

The first keyboard data memory unit stores keyboard layout data and font data to be displayed associated with key locations of the keyboard layout data. The second keyboard data memory unit stores additional keyboard layout data and additional font data to be displayed associated with key locations of the additional keyboard layout data. The additional keyboard registration control unit controls registration of the additional keyboard layout data and the additional font data to the second keyboard data memory unit. The display keyboard creation unit, based on an instruction, selects keyboard layout data from the first and/or second keyboard data memory unit(s), and creates display keyboard data from the selected keyboard layout data and font data associated with key locations of the selected keyboard layout data.

The present invention can also include a modification control unit that, based on an instruction, alters font data of the first and/or the second keyboard data memory unit(s) to be displayed associated with the key locations of the selected keyboard layout data and controls output of the font data to the display keyboard creation unit.

A further embodiment of the present invention can also include a modification control unit that, based on an instruction, modifies a portion of the keyboard layout of the selected keyboard layout data and controls output of the data to the display keyboard creation unit.

A yet further embodiment of the present invention can include an additional keyboard registration control unit for controlling registration of additional keyboard layout data and additional font data for a plurality of languages.

Furthermore, a keyboard management program of the present invention is for causing a computer, with respect to a keyboard-layout-data- and font-data-management and -control device for storing and managing keyboard layout data and font data to be displayed associated with key locations of the keyboard layout data at the first keyboard data memory unit, to perform: memory processing for storing additional keyboard layout data and additional font data to be displayed associated with key locations of the keyboard layout data to a second keyboard data memory unit; and display keyboard creation processing for, based on an instruction, selecting keyboard layout data from the first and second keyboard data memory unit, and creating display keyboard data with the selected keyboard layout data and font data associated with key locations of the keyboard layout data.

A device and a program for keyboard management of the present invention store keyboard layout data and font data to be displayed associated with key locations of the keyboard layout data to a first keyboard data memory unit. They also store additional keyboard layout data and additional font data to be displayed associated with key locations of the additional keyboard layout data into a second keyboard data memory unit, and control registration of the additional keyboard layout data and the additional font data to the second keyboard data memory unit at an additional keyboard registration control unit. Based on an instruction, they select a keyboard from the first and/or the second keyboard data memory unit(s), and create display keyboard data from the selected keyboard layout data and font data associated with key locations of the selected keyboard layout data at a display keyboard creation unit. This configuration enables to switch displaying any multiple keyboards.

Additionally, a configuration comprising a modification control unit that, based on an instruction, alters font data of the first and/or the second keyboard data memory unit(s) to be displayed associated with the key locations of the selected keyboard layout data, and controls output of the data to the display keyboard creation unit allows modification of each font in a key layout of the selected keyboard layout.

A configuration further comprising a modification control unit modifying a portion of the keyboard layout of the aforementioned selected keyboard layout data and controlling output of the data to the display keyboard creation unit enables modification of a key layout of the selected keyboard layout.

Furthermore, a configuration including the aforementioned additional keyboard registration control unit for controlling registration of additional keyboard layout data and additional font data for a plurality of languages enables switching display of multiple language keyboards.

These and other objects, features and advantages of the present invention are specifically set forth in or with become apparent from the following detailed descriptions of the invention when read in conjunction with the accompanying drawings.

### BRIEF DESCRIPTION OF THE DRAWINGS

FIG. 1 is a block diagram illustrating an example of a conventional image forming device.

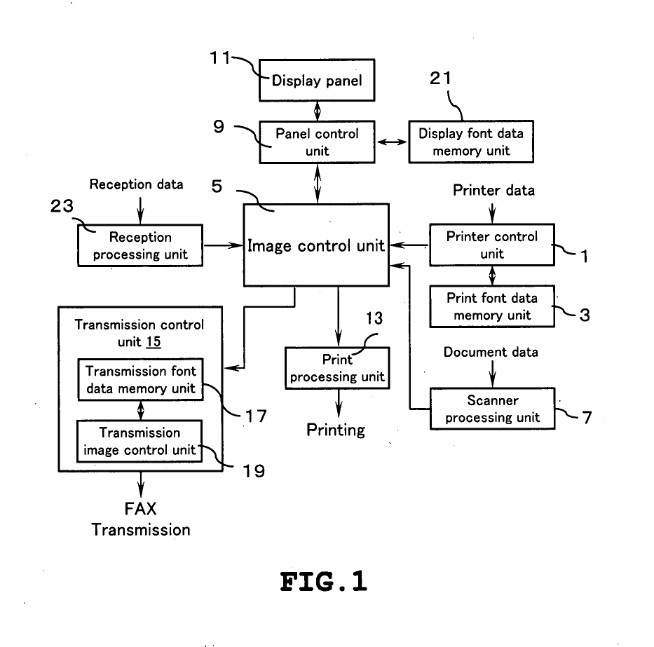

FIG. 2 is a block diagram illustrating a preferred embodiment of a keyboard management device of the present invention on a MFP.

FIG. 3 is a block diagram illustrating a configuration example of the panel control unit of FIG. 2.

FIG. 4 is a drawing illustrating an additional display keyboard (English) example.

FIG. 5 is a drawing illustrating an additional display keyboard (German) example.

FIG. 6 is a drawing illustrating an additional display keyboard (Russian) example.

### DETAILED DESCRIPTION OF THE INVENTION

Exemplary embodiments of the present invention are explained below with reference to the accompanying drawings though these embodiments are not intended to limit the invention. Additionally, in some instances, well-known structures, interfaces, and processes have not been shown in detail in order not to unnecessarily obscure the present invention.

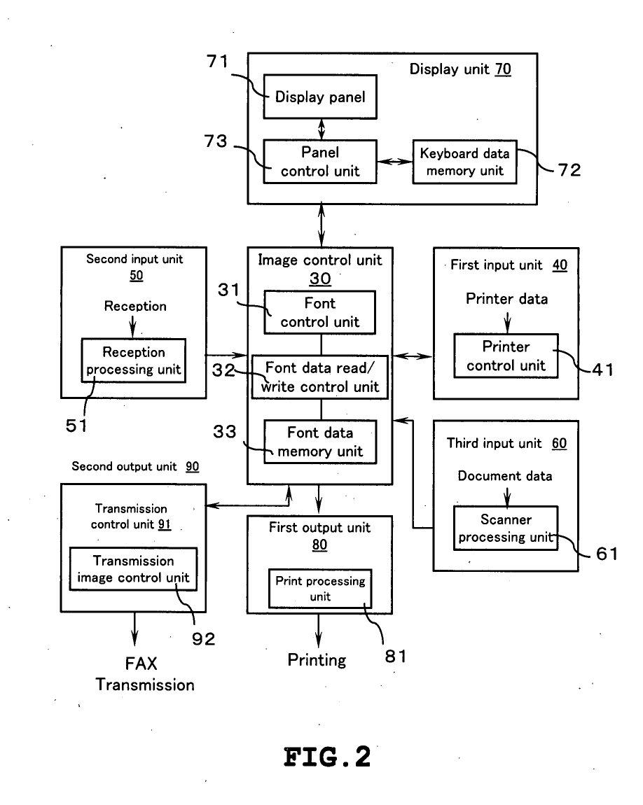

FIG. 2 is a block diagram indicating a preferred embodiment of a keyboard management device of the present invention installed on a MFP.

As shown in FIG. 2, a MFP with a keyboard management device of the present invention installed is an image forming device that includes an image control unit 30 as the schematic hub, a first input unit 40, a second input unit 50, the third input unit 60, a display unit 70, the first output unit 80, and a second output unit 90.

The image control unit 30 includes a font control unit 31, a font data read-and-write control unit 32, and a font data memory unit 33. The detailed functions are described hereinafter.

The first input unit 40 has a printer control unit 41 and functions of inputting printer (image) data from a computer not shown in the drawing to the printer control unit 41, creating print image data at the printer control unit 41 with font data acquired through the font control unit 31, which is described hereinafter, as well as outputting the data to the image control unit 30.

The second input unit 50 includes a reception processing control unit 51 and a function of deciphering data received through a network (not shown), such as a facsimile reception signal, to convert the data into image data. It also outputs the converted data to the image control unit 30, or inputs, for example, additional language data, to be described hereinafter.

Language data includes identification data which presents a country code, character string data which is constituted of character codes to be displayed arranged in a table format, font (character) data associated with the character code and others for displaying on the display unit 70 and for printing and transmission, and keyboard data indicating font data associated with software keyboard layout data and key location supporting to a language. This specification simply describes character codes, font data, keyboard layout data, and key font data among others composing language data.

A third input unit 60 includes a conventional scanner processing unit 61 with functions of reading document data, converting it into digital image data, and outputting it to the image control unit 30.

The display unit 70 includes a display panel 71, a keyboard data memory unit 72 composing a keyboard management device of the present invention, and a panel control unit 73. The detailed functions are described hereinafter.

A first output unit 80 is constituted of a conventional printer engine and others which output print image data output from the first input unit 40, the second input unit 50, and the third input unit 60 through the image control unit 30 on a paper.

The second output unit 90 is a transmission control unit 91 which converts image data into a certain transmission signal and transmits the data to an external network (not shown) through a certain protocol, for example, through facsimile. The second output unit 90 has a transmission image control unit 92 which adds the name and/or the ID of the transmitter and/or the recipient constituted of transmission font data output from the font control unit 31 to the header and/or the footer of the transmission image data

The image control unit 30 performs, on the font control unit 31, the font data read-and-write control unit 32, and the font data memory unit 33, storing of language font data in a read-and-write manner and controlling read-out of the data. It also creates display data for displaying operation status and instructions for various selections, and outputs the data to the panel control unit 73. Based on an instruction from the display panel 71, the image control unit 30 outputs each image data of the printer control unit 41, the scanner processing unit 61, and the reception processing unit 51, to a print processing unit 81 as print image data, and to the transmission control unit 91 as transmission image data. Additionally, the image control unit 30 can perform other functions to be described hereinafter.

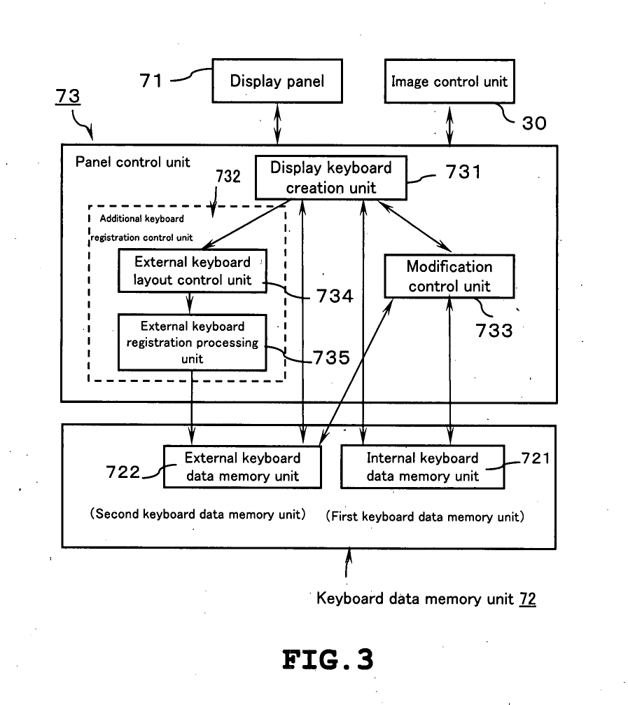

A keyboard data memory unit 72, as illustrated in FIG. 3, includes the internal keyboard data memory unit (the first keyboard data memory unit) 721 having stored keyboard layout data and font data of Japanese as a standard language, corresponding to key locations of the keyboard layout data, to be displayed on the display panel 71, and the external keyboard data memory unit (the second keyboard data memory unit) 722 for storing keyboard layout data and font data of an additional language other than the standard one, corresponding to key locations of the additional language keyboard layout data.

The panel control unit 73 includes a display keyboard creation unit 731, an additional keyboard registration control unit 732, and a modification control unit 733. The additional keyboard registration control unit 732 includes an external keyboard layout control unit 734 and an external keyboard registration processing unit 735.

The display keyboard creation unit 731 in the panel control unit 73 includes a function of controlling storing of additional keyboard layout data and additional font data used for the additional keyboard layout data into a keyboard data memory unit 722, through the external keyboard layout control unit 734 and the external keyboard registration processing unit 735.

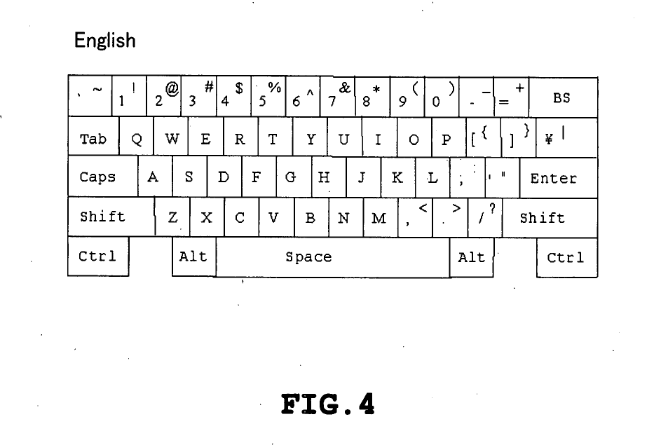

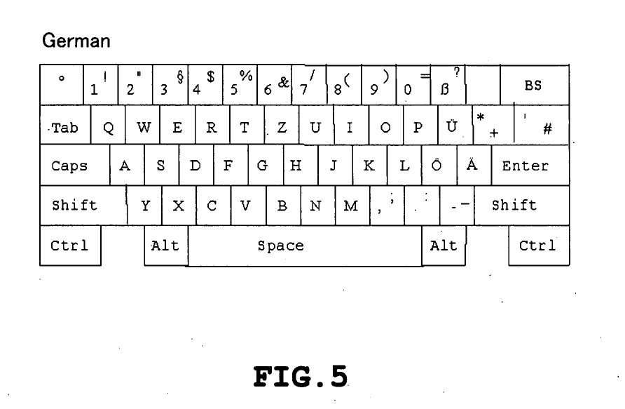

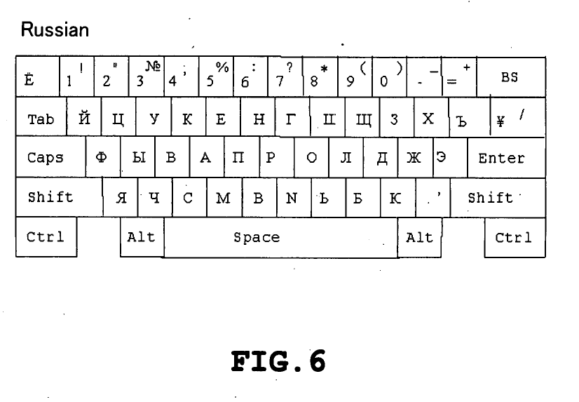

The display keyboard creation unit 731, based on an instruction, selects keyboard layout data from an internal keyboard memory unit 721 and the external keyboard memory unit 722, creates display keyboard data from the selected keyboard layout data and the font data associated with key locations of the keyboard layout data, such as of English (FIG. 4), German (FIG. 5), and Russian (FIG. 6), and controls switching display of keyboard layouts of the display keyboard data on the display panel 71.

Based on an instruction from the display panel 71 through the display keyboard creation unit 731, the modification control unit 733 connected to the display keyboard creation unit 731 reads from the internal keyboard data memory unit 721 and the external keyboard data memory unit 722 font data, different from the one to be displayed having associated with key locations of keyboard layout data read from the internal keyboard data memory unit 721 and the external keyboard data memory unit 722, alters associations of the key locations of the keyboard layout data in relation to the newly read font data, and outputs the altered data to the display keyboard creation unit 731. The display keyboard creation unit 731 also alters and creates display keyboard data and outputs data thereof to the display panel 71.

These functions are performed, for example, for replacing or modifying a display character font of some key locations adjacent to each other in keyboard layout data.

The modification control unit 733 modifies read keyboard data by modifying, deleting, and adding partial locations of the keyboard layout, and outputs the modified keyboard layout data to the display keyboard creation unit 731, based on an instruction from the display panel 71 through the display keyboard creation unit 731. The display keyboard creation unit 731 controls display of the modified keyboard data controls display on the display panel 71. Due to partial modification of a keyboard layout, key font data will also be altered.

The font control unit 31 of FIG. 2 controls output of acquired font data to the panel control unit 73 by converting a format of the data, according to a display mode for displaying the data on the display panel 71. The font control unit 31 also controls output of the acquired font data to the printer control unit 41 by converting a format of the data, according to an image processing mode of print image data. Alternatively, it also controls output of the acquired font data to the transmission image control unit 91 by converting a format of the data, according to an adding mode for the header and/or the footer of transmission image data such as an address book or other document data.

In other words, the font control unit 31 has functions of controlling output of the acquired font data by converting it according to the display mode and other modes used for image data, such as print image data and transmission image data.

The following briefly describes operations of the aforementioned keyboard management device.

First, the additional registration operation, such as for additional language data, will be described.

For instance, if an external memory medium having stored additional font data is connected to the reception process unit 51 in the second input unit 50, based on an instruction from the display panel 71, the font control unit 31 in the image control unit 30 controls storing of external data to the font data memory unit 33 through the font control unit 31 and the font data read-and-write registration unit 32 by associating the external font data with a character code and.

When the image control unit 30 sends keyboard layout data and key font data of additional language data to the panel control unit 73, the panel control unit 73 stores keyboard layout data and key font data used for the keyboard layout data into the external keyboard data memory unit 722 through the external keyboard layout control unit 734 and the external keyboard registration processing unit 735.

Then, for displaying additional keyboard layout data and so forth on the display panel 71, upon an instruction by the display panel 71 to select a keyboard, keyboard layout data and key font data used for the keyboard layout data are read from the keyboard data memory unit 72 for display keyboard layout data to be created and displayed on the display panel 71 in an output-control manner.

A keyboard management device of the present invention configured as above-described further includes the internal keyboard data memory unit (the first keyboard data memory unit) 721 for storing in advance keyboard data to be displayed on the display panel 71 and font data to be displayed associated with key locations of the keyboard data, the external keyboard data memory unit (the second keyboard data memory unit) 722 for storing additional keyboard data and additional font data to be displayed associated with key locations of the keyboard data, the additional keyboard registration control unit 732 for controlling registration of the additional keyboard data and additional font data to the external keyboard data memory unit 722, and the display keyboard creation unit 731 for creating display keyboard data from keyboard data selected from the internal keyboard data memory unit 721 and the external keyboard data memory unit 722 and font data associated with key locations of the selected keyboard data.

Accordingly, a plurality of keyboard layout data and key font data allocated to them enable display of any keyboards.

Additionally, the modification control unit 733 allows a modification of font data corresponding to key locations of selected keyboard layout data, thereby also improves usability of the keyboard management method.

The modification control unit 733 further improves the usability with functions of moving, deleting, and adding a part of selected keyboard layout data, in addition to allocation of font data.

Because the additional keyboard registration control unit 732 manages and controls storing of multiple types of language keyboard layout data by each language, various language keyboard layouts can be easily added or modified, and more conveniently, displayed in a switch-display manner. These advantages will help promote the use in a variety of countries.

Alternatively, the keyboard management device of the present invention can operate not only on character font data, but also on other font data such as of characters and symbol codes.

The keyboard management program of the present invention is for causing a computer, with respect to keyboard-layout-data- and font-data-management and -control device including the display keyboard creation unit 731 having the panel unit 73 as a main unit for storing in advance and managing keyboard layout data and font data to be displayed associated with key locations of keyboard layout data at the internal keyboard data memory unit 721, to perform: memory processing for storing additional keyboard layout data and additional font data to be displayed associated with key locations of the additional keyboard layout data; and display keyboard creation processing for, based on an instruction, selecting keyboard layout data and font data associated with key locations of the keyboard layout data from the internal keyboard data memory unit 721 and the external keyboard data memory unit 722 and creating display keyboard data.

The present document incorporates by reference the contents of Japanese priority document, Japanese Patent Application No. 2006-090075, filed in Japan on Mar. 29, 2006.

Although the invention has been described with respect to a specific embodiment for a complete and clear disclosure, the appended claims are not be thus limited but are to be construed as embodying all modifications and alternative constructions that may occur to one skilled in the art which fairly fall within the basic teaching herein set forth. There are changes that may be made without departing from the spirit and scope of the invention.

Any element in a claim that does not explicitly state “means for” performing a specific function, or “step for” performing a specific function, is not to be interpreted as a “means” or “step” clause as specified in 35 U.S.C. 112, Paragraph 6. In particular, the use of “step(s) of” or “method step(s) of” in the claims herein is not intended to invoke the provisions of 35 U.S.C. 112, Paragraph 6.

What is claimed is:

1. A keyboard management device comprising:
a first keyboard data memory unit for storing keyboard layout data and font data to be displayed associated with key locations of the keyboard layout data;
a second keyboard data memory unit for storing additional keyboard layout data and additional font data to be displayed associated with key locations of the additional keyboard layout data;
an additional keyboard registration control unit for controlling registration of the additional keyboard layout data and the additional font data to the second keyboard data memory unit;
and a display keyboard creation unit for, based on an instruction, selecting the keyboard from the first and/or the second keyboard data memory unit(s), and creating display keyboard data from the selected keyboard layout data and font data associated with key locations of the selected keyboard layout data.

2. The keyboard management device of claim 1, further comprising:
a modification control unit for, based on an instruction, altering the font data in the first and/or the second keyboard data memory unit(s) to be displayed associated with the key locations of the selected keyboard layout data and controlling output of the altered data to the display keyboard creation unit.

3. The keyboard management device of claim 1, further comprising:
a modification control unit for, based on an instruction, modifying a part of the selected keyboard layout data and controlling output of the modified data to the display keyboard creation unit.

4. The keyboard management device of claim 1, wherein:
the additional keyboard registration control unit controls registration of additional keyboard layout data and additional font data for a plurality of languages.

5. The keyboard management device of claim 2, wherein:
the additional keyboard registration control unit controls registration of additional keyboard layout data and additional font data for a plurality of languages.

6. The keyboard management device of claim 3, wherein:
the additional keyboard registration control unit controls registering of additional keyboard layout data and additional font data for a plurality of languages.

7. A program for causing a computer, with respect to a keyboard-layout-data- and font-data-management and -control device that stores and manages keyboard layout data and font data to be displayed associated with key locations of the keyboard layout data at the first keyboard data memory unit, to perform the method steps of:
memory processing for storing additional keyboard layout data and additional font data to be displayed associated with key locations of the keyboard layout data to the second keyboard data memory unit; and
display keyboard creation processing for, based on an instruction, selecting the keyboard layout data from the first and second keyboard data memory unit, and creating display keyboard data from the selected keyboard layout data and font data associated with key locations of the keyboard layout data.

8. The program of claim 7, further comprising:
a modification control unit for, based on an instruction, altering the font data in the first and/or the second keyboard data memory unit(s) to be displayed associated with the key locations of the selected keyboard layout data and controlling output of the altered data to the display keyboard creation unit.

9. The program of claim 7, further comprising:
a modification control unit for, based on an instruction, modifying a part of the selected keyboard layout data and controlling output of the modified data to the display keyboard creation unit.

10. The program of claim 7, wherein:
the additional keyboard registration control unit controls registration of additional keyboard layout data and additional font data for a plurality of languages.

11. A method for managing a keyboard, comprising:
memory processing for storing additional keyboard layout data and additional font data to be displayed associated with key locations of the keyboard layout data to the second keyboard data memory unit; and
display keyboard creation processing for, based on an instruction, selecting the keyboard layout data from the first and second keyboard data memory unit, and creating display keyboard data from the selected keyboard layout data and font data associated with key locations of the keyboard layout data.

12. The method of claim 11, further comprising:
a modification control unit for, based on an instruction, altering the font data in the first and/or the second keyboard data memory unit(s) to be displayed associated with the key locations of the selected keyboard layout data and controlling output of the altered data to the display keyboard creation unit.

13. The method of claim 11, further comprising:
a modification control unit for, based on an instruction, modifying a part of the selected keyboard layout data and controlling output of the modified data to the display keyboard creation unit.

14. The method of claim 11, wherein:
the additional keyboard registration control unit controls registration of additional keyboard layout data and additional font data for a plurality of languages.
